(19) United States
(12) Patent Application Publication
(10) Pub. No.: US 2015/0231556 A1
(43) Pub. Date: Aug. 20, 2015

(54) Method Of Manufacturing A Silicone Membrane

(71) Applicant: Dow Corning Corporation, Midland, MI (US)

(72) Inventors: Dongchan Ahn, Midland, MI (US); James Hrabal, St. Louis, MI (US); Alexandra Lichtor, Midland, MI (US)

(21) Appl. No.: 14/425,101

(22) PCT Filed: Nov. 6, 2013
(86) PCT No.: PCT/US2013/068658

§ 371 Date: Mar. 2, 2015

Related U.S. Application Data
(60) Provisional application No. 61/722,887, filed on Nov. 6, 2012.

(51) Int. Cl. B01D 53/22; B29C 39/02; B01D 71/70; B01D 67/00; B01D 69/12

(52) U.S. Cl. CPC B01D 53/228; B01D 67/0079; B01D 69/12; B01D 71/70; B29C 39/02; B01D 53/22; B01D 2323/12; B01D 2325/20; B29L 2031/755

(57) ABSTRACT

The present invention relates to silicone membranes, and methods of making and using the same. The present invention provides a silicone membrane including a cured product of a mixture, the mixture including a film including a silicone elastomer having a plurality of silicon-bonded hydrogen atoms and a composition in contact with at least one side of the film including a poly(alkylene oxide) having at least one unsaturated aliphatic carbon-carbon bond. The present invention also includes methods of making the membrane, and methods of using the membrane.

This application claims the benefit of priority to U.S. Provisional Patent Application Ser. No. 61/722,887 entitled “METHOD OF MANUFACTURING A SILICONE MEMBRANE,” filed Nov. 6, 2012, the disclosure of which is incorporated herein in its entirety by reference.

Artificial membranes can be used to perform separations on both a small and large scale, which makes them very useful in many settings. For example, membranes can be used to purify water, to cleanse blood during dialysis, and to separate gases. Some common driving forces used in membrane separations are pressure gradients and concentration gradients. Membranes can be made from polymeric structures, for example, and can have a variety of surface chemistries, structures, and production methods. Membranes can be made by hardening or curing a composition.

The use of membranes to separate gases is an important technique that can be used in many types of procedures. Examples can include recovery of hydrogen gas in ammonia synthesis, recovery of hydrogen in petroleum refining, separation of methane from other components in biogas synthesis, enrichment of air with oxygen for medical or other purposes, removal of water vapor from air or natural gas, removal of carbon dioxide (CO₂) from natural gas or biogas, removal of entrained gases from liquids, introduction of water vapor for humidification or moisturization, and carbon-capture applications such as the removal of CO₂ from flue gas streams generated by combustion processes.

### SUMMARY OF THE INVENTION

The present invention provides a silicone membrane including a cured product of a composition-contacted film including a film including a silicone elastomer having a plurality of silicon-bonded hydrogen atoms and a composition in contact with at least one side of the film including a poly(alkylene oxide) having at least one unsaturated aliphatic carbon-carbon bond.

The present invention provides advantages over other known membranes. For example, in some embodiments surprisingly by contacting the silicone elastomer-containing film having Si—H groups with the poly(alkylene oxide) containing at least one unsaturated aliphatic carbon-carbon bond, the gas selectivity properties of the resulting silicone membrane are improved, while maintaining high permeability. For example, membranes of the present invention can exhibit both high permeability and selectivity for particular components in a gas mixture. For example, in some embodiments the membrane of the present invention can exhibit high selectivity for one or more particular gases in mixtures, such as high CO₂/N₂ or CO₂/CH₄ selectivity, or high selectivity for water in various gas mixtures, compared to other membranes, such as compared to polydimethylsiloxane membranes cured by hydrosilylation, while retaining high permeability for the one or more particular gases. Various embodiments can provide a method of separating gas mixtures for a variety of industrially important and energy/environment driven applications such as carbon capture, natural gas sweetening, and production of hydrogen. In some embodiments, the membranes or modules including the membranes can be useful for removal of CO₂ or water vapor from gas mixtures. In some embodiments, the membranes of the present invention can provide enhanced resistance to biofouling in liquid-contacting applications.

In various embodiments, the present invention provides a silicone membrane. The silicone membrane is a cured product of a composition-contacted film. The composition-contacted film includes a film including a silicone elastomer. The silicone elastomer includes a plurality of silicon-bonded hydrogen atoms. The composition-contacted film also includes a composition in contact with at least one side of the film. The composition includes an unsaturated an unsaturated poly(alkylene oxide) having the formula R¹O(R²O)ₙR³. The group R¹ is an organic group having at least one unsaturated aliphatic carbon-carbon bond. The group R² is C₂-C₄ hydrocarbylene. The group R³ is R¹, H, alkyl, aryl, acyl, alkylacyl, alkoxyacyl, or an epoxy-functional group. The variable n is about 2 to 30. The composition optionally includes a platinum group metal-containing catalyst. The silicone membrane has a CO₂ permeance of at least about 8-30 GPU.

In various embodiments, the present invention provides a method of preparing a silicone membrane. The method includes contacting at least one surface of a film with a composition. The film includes a silicone elastomer having a plurality of silicon-bonded hydrogen atoms. The composition includes an unsaturated poly(alkylene oxide) having the formula R¹O(R²O)ₙR³. The group R¹ is an organic group having at least one unsaturated aliphatic carbon-carbon bond. The group R² is C₂-C₄ hydrocarbylene. The group R³ is R¹, H, alkyl, aryl, acyl, alkylacyl, alkoxyacyl, or an epoxy-functional group. The variable n is about 2 to 30. The composition optionally includes a platinum group metal-containing catalyst. The surface of the film and the composition are contacted for an amount of time sufficient to convert at least a portion of the silicon-bonded hydrogen atoms to silicon-bonded carbon groups. The contacting gives a silicone membrane. The silicone membrane has a CO₂ permeance of at least about 8-30 GPU.

In various embodiments, the present invention provides a method of separating gas components in a feed gas mixture. The method includes contacting a first side of a silicone membrane of the present invention or made by the method of the present invention, with a feed gas mixture. The feed gas mixture includes at least a first gas component and a second gas component. The contacting produces a permeate gas mixture on a second side of the membrane. The contacting also produces a retentate gas mixture on the first side of the membrane. The permeate gas mixture is enriched in the first gas component. The retentate gas mixture is depleted in the first gas component.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

The patent or application file contains at least one drawing executed in color. Copies of this patent or patent application publication with color drawing(s) will be provided by the Office upon request and payment of the necessary fee.

FIG. 1 illustrates CO₂ permeability and CO₂/N₂ selectivity versus the sum of PEG:Si—Me IR peak ratios, in accordance with various embodiments.

### DETAILED DESCRIPTION OF THE INVENTION

Reference will now be made in detail to certain claims of the disclosed subject matter, examples of which are illustrated in the accompanying drawings. While the disclosed subject matter will be described in conjunction with the enumerated claims, it will be understood that the exemplified subject matter is not intended to limit the claims to the disclosed subject matter.

References in the specification to “one embodiment,” “an embodiment,” “an example embodiment,” and the like, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to effect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range. When a range or a list of sequential values is given, unless otherwise specified any value within the range or any value between the given sequential values is also disclosed.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. Examples include acyl, cycloalkyl, aryl, aralkyl, heterocyclyl, heteroaryl, or heteroarylalkyl, linear and/or branched groups such as alkyl groups, fully or partially halogen-substituted haloalkyl groups, alkenyl groups, alkynyl groups, acrylate and methacrylate functional groups; and other organic functional groups such as ether groups, cyanate ester groups, ester groups, carboxylate salt groups, and masked isocyano groups.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule, or onto an organic group. Examples of substituents or functional groups include, but are not limited to, any organic group, a halogen (e.g., F, Cl, Br, and I); a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups.

The term “alkyl” as used herein refers to straight chain and branched alkyl groups and cycloalkyl groups having from 1 to about 20 carbon atoms, and typically from 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups.

Examples of branched alkyl groups include, but are not limited to, isopropyl, isobutyl, sec-butyl, t-butyl, neopentyl, isopentyl, and 2,2-dimethylpropyl groups. As used herein, the term “alkyl” encompasses all branched chain forms of alkyl. Representative substituted alkyl groups can be substituted one or more times with any functional group, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to about 20 carbon atoms, and typically from 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others.

The term “aryl” as used herein refers to cyclic aromatic hydrocarbons that do not contain heteroatoms in the ring.

The term “acyl” as used herein can refer to a group containing a carbonyl moiety wherein the group is bonded via the carbonyl carbon atom. The carbonyl carbon atom can also be bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) group is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group. In some examples, acyl groups can include esters, carboxylic acids, carboxylic acid salts, and aldehydes.

The terms “epoxy-functional” or “epoxy-substituted” as used herein refers to a functional group in which an oxygen atom, the epoxy substituent, is directly attached to two adjacent carbon atoms of a carbon chain or ring system. Examples of epoxy-substituted functional groups include, but are not limited to, 2,3-epoxypropyl, 3,4-epoxybutyl, 4,5-epoxypentyl, 2-glycidoxyethyl, 3-glycidoxypropyl, 4-glycidoxybutyl, 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3-epoxycylopentyl)propyl.

The term “hydrocarbyl” or “hydrocarbon” as used herein refers to a functional group or molecule that includes carbon and hydrogen atoms that can be substituted or unsubstituted. The term can also refer to a functional group or molecule that normally includes both carbon and hydrogen atoms but wherein all the hydrogen atoms are substituted with other functional groups.

The term “resin” as used herein refers to polysiloxane material of any viscosity that includes at least one siloxane monomer that is bonded via a Si—O—Si bond to three or four other siloxane monomers. In one example, the polysiloxane material includes T or Q groups, as defined herein.

The term “number-average molecular weight” as used herein refers to the ordinary arithmetic mean of the molecular weight of individual molecules in a sample. It is defined as the total weight of all molecules in a sample divided by the total number of molecules in the sample. The number average molecular weight (Mₙ) is equal to ΣMᵢnᵢ/Σnᵢ, where nᵢ is the number of molecules of molecular weight Mᵢ. The number average molecular weight can be experimentally measured by a variety of well-known methods including gel permeation chromatography, spectroscopic end group analysis, and osmometry.

The term “weight-average molecular weight” as used herein refers (M_{W}), which is equal to ΣMᵢ²nᵢ/ΣMᵢnᵢ, where nᵢ is the number of molecules of molecular weight Mᵢ. In various examples, the weight average molecular weight can be determined using light scattering, small angle neutron scattering, X-ray scattering, and sedimentation velocity.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation.

The term “cure” as used herein refers to exposing to radiation in any form, heating, or allowing to undergo a physical or chemical reaction that results in hardening or an increase in viscosity.

The term “pore” as used herein refers to a depression, slit, or hole of any size or shape in a solid object. A pore can run all the way through an object or partially through the object. A pore can intersect other pores.

The term “free-standing” or “unsupported” as used herein refers to a membrane with the majority of the surface area on each of the two major sides of the membrane not contacting a substrate, whether the substrate is porous or not. In some embodiments, a membrane that is “free-standing” or “unsupported” can be 100% not supported on both major sides. A membrane that is “free-standing” or “unsupported” can be supported at the edges or at the minority (e.g. less than about 50%) of the surface area on either or both major sides of the membrane.

The term “supported” as used herein refers to a membrane with the majority of the surface area on at least one of the two major sides contacting a substrate, whether the substrate is porous or not. In some embodiments, a membrane that is “supported” can be 100% supported on at least one side. A membrane that is “supported” can be supported at any suitable location at the majority (e.g. more than about 50%) of the surface area on either or both major sides of the membrane.

The term “enrich” as used herein refers to increasing in quantity or concentration, such as of a liquid, gas, or solute. For example, a mixture of gases A and B can be enriched in gas A if the concentration or quantity of gas A is increased, for example by selective permeation of gas A through a membrane to add gas A to the mixture, or for example by selective permeation of gas B through a membrane to take gas B away from the mixture.

The term “deplete” as used herein refers to decreasing in quantity or concentration, such as of a liquid, gas, or solute. For example, a mixture of gases A and B can be depleted in gas B if the concentration or quantity of gas B is decreased, for example by selective permeation of gas B through a membrane to take gas B away from the mixture, or for example by selective permeation of gas A through a membrane to add gas A to the mixture.

The term “solvent” as used herein refers to a liquid that can dissolve a solid, liquid, or gas. Nonlimiting examples of solvents are silicones, organic compounds, water, alcohols, ionic liquids, and supercritical fluids.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “silicate” as used herein refers to any silicon-containing compound wherein the silicon atom has four bonds to oxygen, wherein at least one of the oxygen atoms bound to the silicon atom is ionic, such as any salt of a silicic acid. The counterion to the oxygen ion can be any other suitable ion or ions. An oxygen atom can be substituted with other silicon atoms, allowing for a polymer structure. One or more oxygen atoms can be double-bonded to the silicon atom; therefore, a silicate molecule can include a silicon atom with 2, 3, or 4 oxygen atoms. Examples of silicates include aluminum silicate. Zeolites are one example of materials that can include aluminum silicate. A silicate can be in the form of a salt, ion, or a neutral compound.

The term “selectivity” or “ideal selectivity” as used herein refers to the ratio of permeability of the faster permeating gas over the slower permeating gas, measured at room temperature unless otherwise indicated.

The term “permeability” as used herein refers to a thickness- and partial pressure normalized flux, or the permeability coefficient (Pₓ), of substance X through a membrane, where qₘₓ=Pₓ*A*Δpₓ*(1/δ), where qₘₓ is the volumetric flow rate of substance X through the membrane, A is the surface area of one major side of the membrane through which substance X flows, Δpₓ is the pressure difference of the partial pressure of substance X across the membrane, and δ is the thickness of the membrane. Pₓ can also be expressed as V·δ/(A·t·Δp), wherein Pₓ is the permeability for a gas X in the membrane, V is the volume of gas X which permeates through the membrane, δ is the thickness of the membrane, A is the area of the membrane, t is time, Δp is the pressure difference of the gas X at the retentate and permeate side. In cases where the membrane is surface treated, it should be noted that the experimentally measured value of permeability may not reflect a true bulk material property, but is rather an effective permeability coefficient for the treated membrane sample. Permeability is measured at room temperature, unless otherwise indicated.

The term “permeance” as used herein refers to the partial pressure normalized flux (Mₓ) of substance X through a membrane, wherein Mₓ=Pₓ/δ=V/(A·t·Δp), wherein Pₓ is the permeability for a gas X in the membrane, V is the volume of gas X which permeates through the membrane, δ is the thickness of the membrane, A is the area of the membrane, t is time, Δp is the pressure difference of the gas X at the retente and permeate side. Permeance is measured at room temperature, unless otherwise indicated.

The term “Barrer” or “Barrers” as used herein refers to a unit of permeability, wherein 1 Barrer=10⁻¹¹ (cm³ gas) cm cm⁻² s⁻¹, mmHg⁻¹, or 10⁻¹⁰ (cm³ gas) cm cm⁻² s⁻¹ cm Hg⁻¹, where “cm³ gas” represents the quantity of the gas that would take up one cubic centimeter at standard temperature and pressure.

The term “total surface area” as used herein with respect to membranes refers to the total surface area of the side of the membrane exposed to the feed gas mixture.

The term “air” as used herein refers to a mixture of gases with a composition approximately identical to the native composition of gases taken from the atmosphere, generally at ground level. In some examples, air is taken from the ambient surroundings. Air has a composition that includes approximately 78% nitrogen, 21% oxygen, 1% argon, and 0.04% carbon dioxide, as well as small amounts of other gases.

The term “room temperature” as used herein refers to ambient temperature, which can be, for example, between about 15° C. and about 28° C.

The term “coating” as used herein refers to a continuous or discontinuous layer of material on the coated surface, wherein the layer of material can penetrate the surface and can fill areas such as pores, wherein the layer of material can have any three-dimensional shape, including a flat or curved plane. In one example, a coating can be formed on one or more surfaces, any of which may be porous or nonporous, by immersion in a bath of coating material.

The term “surface” as used herein refers to a boundary or side of an object, wherein the boundary or side can have any perimeter shape and can have any three-dimensional shape, including flat, curved, or angular, wherein the boundary or side can be continuous or discontinuous. While the term surface generally refers to the outermost boundary of an object with no implied depth, when the term ‘pores’ is used in reference to a surface, it refers to both the surface opening and the depth to which the pores extend beneath the surface into the substrate.

The term “mil” as used herein refers to a thousandth of an inch, such that 1 mil=0.001 inch.

As used herein, the term “polymer” refers to a molecule having at least one repeating unit.

The term “copolymer” as used herein refers to a polymer that includes at least two different monomers. A copolymer can include any suitable number of monomers. A copolymer can be, for example, alternating, graft, periodic, statistical, random, or block.

The term “gas” as used herein includes vapor phase materials.

### Silicone Membrane

In various embodiments, the present invention provides a silicone membrane, and a method of making the same. The silicone membrane is a cured product of a composition-contacted film. The composition-contacted film includes a silicone elastomer having a plurality of silicon-bonded hydrogen atoms and a composition including a poly(alkylene oxide) in contact with at least one side of the film. The contacting occurs for a period of time and at a temperature such that at least some of the silicon-hydrogen bonds are converted into silicon-carbon bonds. The silicon-carbon bonds form via a hydrosilylation reaction between the silicon-hydrogen groups and the unsaturated groups of the poly(alkylene oxide). In the hydrosilylation reaction, a silicon-hydrogen group of the silicone elastomer adds across an unsaturated group of the poly(alkylene oxide) during curing, causing the unsaturated group to lose at least one degree of unsaturation (e.g., a double bond is converted to a single bond), such that the silicon atom is bound to one carbon atom of the originally unsaturated group, and the hydrogen atom is bound to the other carbon atom of the originally unsaturated group.

The method of preparing the membrane includes contacting at least one surface of the film with the composition including the poly(alkylene oxide). The contacting can be any suitable contacting. For example, the contacting can be immersion, dipping, brushing, roll coating, printing, or spraying. The at least one surface contacted can be one of the two major opposing surfaces of the film. The at least one surface contacted can be both of the two major opposing surfaces of the film. Each surface can be contacted for the same amount of time. In some examples, each surface can be contact for different amounts of time. An entire surface of the film can be contacted, or any suitable portion of the surface can be contacted, in any suitable pattern.

The contacting of the film can occur with the film in any suitable shape or configuration, such that the resulting silicone membrane is in the desired form or can be formed into the desired form. For example, the film can be in the shape of a hollow fiber during the contacting, to give a silicone membrane having a hollow fiber shape. In some embodiments, the film can be on a substrate during the contacting, to give a silicone membrane supported on a substrate, or to peel the resulting silicone membrane off the substrate to give a free-standing membrane; or the peeled silicone membrane can then be placed on another support to give a supported membrane. In some embodiments, during the contacting the film can be the configuration of a plate-and-frame, spiral wound, a tubular, or a capillary fiber membrane, to give a silicone membrane having the corresponding shape. For the film or membrane to be considered “on” a substrate, it can be attached (e.g. adhered) to the substrate, or be otherwise in contact with the substrate without being adhered. The substrate can have any surface texture, and can be porous or non-porous. The substrate can include surfaces that are not on the film or membrane.

The contacting is performed until at least some of the silicon-hydrogen bonds are converted into silicon-carbon bonds via reaction with the unsaturated poly(alkylene oxide). For example, the contacting can be performed until at least about 0.01%, 0.1%, 1%, 2%, 3%, 4%, 5%, 10%, 20%, 30%, 40%, 50%, 60%, 70%, 80%, 90%, 95%, 96%, 97%, 98%, 99%, 99.9%, or until at least about 99.99% or more of the silicon-hydrogen bonds of the silicon elastomer have undergone a hydrosilylation reaction with an unsaturated bond of the poly(alkylene oxide).

The contacting can occur for any suitable amount of time, such that at least some of the silicon-hydrogen bonds are converted into silicon-carbon bonds via reaction with an unsaturated group on the poly(alkylene oxide). To cause a particular proportion of the silicon-hydrogen bonds to undergo a hydrosilylation reaction, the amount of time used can vary depending on the temperature during the contacting. At higher temperatures, a shorter time of contacting can be used. At lower temperatures, a longer time of contacting can be used. The contacting can occur at any suitable temperature, such that at least some of the silicon-hydrogen bonds are converted into silicon-carbon bonds via reaction with an unsaturated group on the poly(alkylene oxide). To cause a particular proportion of the silicon-hydrogen bonds to undergo a hydrosilylation reaction, the temperature used during the contacting can vary depending on the duration of the contacting. At longer times, a lower temperature of contacting can be used. At lower temperatures, a higher temperature of contacting can be used. The contacting can occur in the presence of any suitable amount of radiation, including substantially no radiation. The contacting can occur in the presence of any suitable amount of moisture, including substantially no moisture. The combination of suitable proportions of time, temperature (e.g., ambient or greater), pressure, atmosphere (e.g. in air or in limited oxygen conditions), optional moisture, and optional radiation can be adjusted to achieve the desired amount of hydrosilylation to occur between the silicone elastomer and the poly(alkylene oxide)

After contacting for a suitable amount of time and at a suitable temperature, optionally silicone membrane can be washed, for example to remove from the surface residual unreacted material from the composition including the poly(alkylene oxide), such as unreacted poly(alkylene oxide), catalyst, byproducts of the hydrosilylation reaction, or other materials. In some embodiments, the washing is performed. In some embodiments, the washing is not performed. The washing can be any suitable washing. For example, the washing can be immersion, dipping, brushing, roll coating, printing, rinsing, or spraying. The washing can include cycles involving repetition of any single method or combinations of methods. The washing can be conducted using any one solvent or any combination of solvents, such as one or more solvents that with which the components desired to be washed from the surface are soluble or miscible. In some embodiments, the washing can be conducted using any one solvent or any combination of solvents that are a poor solvent or non-solvent for the membrane. The washing can be conducted for any suitable time and at any suitable temperature, such that the desired amount of material is removed from the surface of the silicone membrane. For example, the one or more solvents can be water, or any organic solvent. In some examples, the surface can be wiped or agitated to remove residual unreacted material, such as the materials described in this paragraph. The surface can be wiped in addition to, or as an alternative to, washing. When wiping is combined with washing, the wiping can be performed at least one of before the washing and after the washing. The washing, the wiping, or a combination thereof, can substantially remove unreacted poly(alkylene oxide) from the surface of the silicone membrane. The surface may be further dried after the one or more washing and/or wiping steps prior to use. In some embodiments, drying may be accomplished by subjecting the surface to any combination of time, temperature, pressure, and gas or liquid flow, or absorption by a solid or liquid medium.

The composition-contacted film is cured during at least part of the contacting to allow the silicon-bonded hydrogen atoms of the silicone elastomer to undergo hydrosilylation with the unsaturated groups of the poly(alkylene oxide). In some embodiments, the curing of the composition-contacted film can occur without the addition of any curing agent or initiator (e.g, no hydrosilylation catalyst). In other embodiments, curing the composition-contacted film can include the addition of a curing agent or initiator such as, for example, a hydrosilylation catalyst. Curing the composition-contacted film, whether the composition includes a curing agent or intitiator or not, can include a variety of methods, including exposing to suitable amounts of ambient temperature, elevated temperature (e.g., 30°C., 50, 75, 100, 125, 150, 175, 200, 300, 400, or about 500° C.), moisture (e.g., relative humidity of about 0.01%, 0.1%, 1%, 2%, 3%, 4%, 5%, 10%, 20%, 30%, 40%, 50%, 60%, 70%, 80%, 90%, 95%, 96%, 97%, 98%, 99%, or about 100%), or radiation, for any suitable amount of time (e.g., about 1 min, 10 min, 30 min, 45 min, 1 h, 2 h, 3 h, 4 h, 5 h, 10 h, 24 h, 2 d, 3 d, 4 d, or about 5 d). In some embodiments, curing the composition-contacted film can include combination of methods.

The silicone membrane can have any suitable thickness. In some examples, the membrane has a thickness of from about 1 μm, 5, or 10 μm to about 20 μm, 30, or to about 40 μm, or about 30 μm to about 60 μm, or about 0.1 μm to about 200 μm, 300, or to about 400 μm, or about 0.01 μm to about 2000 μm. The silicone membrane can have any suitable shape. In some examples, the membrane is a plate-and-frame membrane, a spiral wound membrane, a tubular membrane, a capillary fiber membrane or a hollow fiber membrane. The silicone membrane can be a plurality of hollow fibers, or can be a hollow fiber module (e.g, potted hollow fibers). The membrane can be a continuous or discontinuous layer of material.

The one or more membranes of the present invention can be selectively permeable to one substance over another. In one example, the one or more membranes are selectively permeable to one gas over other gases or liquids. In another example, the one or more membranes are selectively permeable to more than one gas over other gases or liquids. In one embodiment, the one or more membranes are selectively permeable to one liquid over other liquids or gases. In another embodiment, the one or more membranes are selectively permeable to more than one liquid over other liquids. In an embodiment, the one or more membranes are selectively permeable to water vapor, carbon dioxide, or methane over other gases or liquids. In some examples, the membrane has a CO₂/N₂ selectivity of at least about 1-150, 10-75, or about 20-40. In some examples, the membrane has a CO₂/CH₄ selectivity of at least about 1-150, 10-75, or about 20-40. In some embodiments, the membrane has a CO₂ permeation coefficient of about 0.001 or less, or at least about 0.01 Barrer, 0.1, 1, 5, 10, 20, 30, 40, 50, 60, 70, 80, 90, 100, 120, 140, 160, 180, 200, 240, 280, 300, 400, 500, 600, 700, 800, 900, 1000, 1200, 1400, 1600, 1800, or at least about 2000 Barrer. In some embodiments, the membrane has a CH₄ permeation coefficient of at least about 0.001 Barrer or less, or at least about 0.001, 0.01, 0.1, 1, 2, 4, 6, 8, 10, 12, 14, 16, 18, 20, 30, 40, 50, 60, 70, 80, 90, or at least about 100 Barrer. In some examples, the one or more membranes have an H₂O in air selectivity of at least about 50, at least about 90, at least about 100, at least about 120, at least about 130, at least about 150, at least about 200, or at least about 250 at room temperature. In some embodiments, with a the one or more membranes has an H₂O in air vapor permeability coefficient of at least about 5,000 Barrer, 10,000 Barrer, 15,000 Barrer, 20,000 Barrer, 25,000 Barrer, 30,000 Barrer, 35,000 Barrer, 40,000 Barrer, 50,000 Barrer, 60,000 Barrer, or at least about 70,000 Barrer at room temperature. In some embodiments, the membrane has a CO₂ permeance of at least about 1-1000 GPU, or 1-100, or the range of 6, 7, 8, 9, or 10 to 50, or the range of 1, 2, 3, 4, 5, 6, 7, 8, 9, 10, 11, 12, 13, 14, 15, 16, 17, or 18 to 30, such as 8-30, or about 8-19 GPU. In some embodiments the membrane has a water vapor permeance of at least about 10-50,000 GPU, or about 10-5,000 GPU.

Permeability and permeance can be measured in any suitable fashion, for example, such as methods described in the Examples.

Unsaturated poly(alkylene oxide)

The composition that is contacted to the membrane includes a poly(alkylene oxide) (e.g., a polyether) having at least one unsaturated aliphatic carbon-carbon bond. The poly(alkylene oxide) can be any suitable poly(alkylene oxide) having at least one unsaturated aliphatic carbon-carbon bond per molecule, wherein the at least one unsaturated aliphatic carbon-carbon bond can participate in a hydrosilylation reaction. The poly(alkylene oxide) can have other carbon-carbon bonds that are not unsaturated. One or more of the unsaturated bonds of each poly(alkylene oxide) molecule can undergo a hydrosilylation reaction with the Si—H groups of the silicone elastomer, forming carbon-carbon bonds and bonding the poly(alkylene oxide) to the silicone elastomer.

A suitable poly(alkylene oxide) molecule can include both unsubstituted and substituted alkylene units. One or more alkylene oxide units can include an alkenyl substituent. The polyalkylene glycol can include alkylene oxide units of any suitable length, including C₁₋₂₀. The alkylene oxide units can be the same throughout a molecule, or can vary in a molecule. In poly(alkylene oxide) molecules that include varying alkylene oxide units, the variation can follow a pattern, or can be random. The alkylene oxide units can be branched or linear, and some examples can have both branched and unbranched alkylene oxide units. In some examples, the alkylene oxide units can be unsubstituted. In other examples, one or more of the alkylene oxide units can be substituted with any suitable functional group.

In one example, the poly(alkylene oxide) can include one or more alkenyl or alkynyl substituents of any suitable carbon length, including C₂₋₂₀. In some examples, a poly(alkylene oxide) species can include unsaturation between two of the carbon atoms in an alkylene oxide unit that directly connects one oxygen atom to another (e.g. in the linear chain of the poly(alkylene oxide)). In some examples, a poly(alkylene oxide) includes unsaturation in the linear chain, in grafted functional groups on the chain, or both, in any suitable random or ordered pattern.

The poly(alkylene oxide) can be substituted at its ends with any suitable functional group. In one example, the poly(alkylene oxide) is substituted on at least one end with a hydrogen atom (H), forming a hydroxyl group or an alkyl group. In one example, the poly(alkylene oxide) can be substituted on at least one end with an alkyl substituent. In some examples, the poly(alkylene oxide) is substituted on one or both ends with an alkyl group that corresponds to the alkylene units included in the poly(alkylene oxide). For example, a polyethylene glycol can be substituted at one or both ends with an ethyl substituent. In other examples, the poly(alkylene oxide) is substituted at one or both ends with a group that does not correspond to the alkylene units included in the poly(alkylene oxide). For example, a polypropylene glycol can be substituted at one or more ends with an acetyl substituent, forming an acetate at one or more ends of the polyalkylene glycol; such a poly(alkylene oxide) can be referred to as an acetate-terminated poly(alkylene oxide). In another example, a polypropylene glycol can be substituted at one or more ends with an ethyl substituent. In some examples, the poly(alkylene oxide) is substituted on at least one end with an alkenyl substituent; in the case of a propylenyl substituent, such a poly(alkylene oxide) can be referred to as an allyl-terminated poly(alkylene oxide); in the case of an ethylenyl substituent, such a poly(alkylene oxide) can be referred to as a vinyl terminated poly(alkylene oxide). In one example, the poly(alkylene oxide) is a allyl-terminated polyalkylene glycol. One suitable example of an allyl-terminated poly(alkylene oxide) is an mono-allyl terminated polyethylene glycol. In some examples, a molecule of the poly(alkylene oxide) has about 1 or 2 unsaturated aliphatic carbon-carbon bonds, or about 3, 4, 5, 6, 7, 8, 9, 10, 15, 20, 25, 30, 35, 40, 45, or about 50 unsaturated aliphatic carbon-carbon bonds.

In some embodiments, the poly(alkylene oxide) has the formula

R⁴(OR⁶)ₑOR⁵,

wherein R⁵ is hydrogen or an organic group independently selected from any optionally further substituted C₁₋₁₅ organic group, including C₁₋₁₅ monovalent aliphatic hydrocarbon groups, C₄₋₁₅ monovalent aromatic hydrocarbon groups, monovalent acyl, alkylacyl, and alkoxyacyl groups, and monovalent epoxy-substituted organic groups, R⁴ is C₂ to C₁₁ alkenyl (e.g. ethenyl, propenyl, butenyl, hexenyl, octenyl, undecylenyl), R⁶ is a linear or branched optionally substituted C₁₋₁₀ alkylene unit, e is from about 1 to about 10,000, wherein R₆ is independently selected (e.g. can be the same or different) for each alkylene unit (e.g. each alkylene oxide unit) of the poly(alkylene oxide). In some embodiments, R⁵ is acetyl (Ac), or R⁵ is allyl. In some embodiments, R⁶ is a halogen substituted linear or branched C₁₋₁₀ alkylene unit.

In some embodiments, the poly(alkylene oxide) is at least one of a poly(alkylene oxide) having the formula R¹O(R²O)ₙR³, a poly(ethylene oxide) having the general formula R¹O(CH₂CH₂O)ₙR³, a poly(propylene oxide) having the general formula R¹O[CH₂CH(CH₃)O]ₙR³, a poly(butylene oxide) having the general formula R¹O[CH₂CH(CH₂CH₃)O]ₙR³, and a poly(ethylene oxide-propylene oxide) copolymer having the formula R¹O(CH₂CH₂O)_{c}[CH₂CH(CH₃)O]_{d}R³, wherein R¹ is an organic group having at least one unsaturated aliphatic carbon-carbon bond such as alkenes (e.g., ethenyl, propenyl, butenyl) or alkynes (e.g., ethynyl, propynyl, butynyl), R² is C₂-C₄ hydrocarbylene (e.g., ethylene, propylene, butylene), R³ is R¹, H, alkyl (e.g., methyl, ethyl, propyl, butyl, pentyl), aryl (e.g., phenyl, naphthyl), acyl (e.g., acetyl, propanoyl, butanoyl), alkylacyl (e.g. 3-oxobutyl, 2-oxopropyl), alkoxyacyl (e.g. acetoxymethyl), or an epoxy-functional group (e.g., 2,3-epoxypropyl, 3,4-epoxybutyl, 4,5-epoxypentyl), n has a value such that the number average molecular weight of the poly(alkylene oxide) is about or about 50 to about 20,000, 75 to about 10,000, or about 90 to 4000, and c+d=n. In some examples, b is about 1 to 1000, 1 to 100, 1 to 50, or about 2 to 30. The groups R¹, R², and R³ can include linear or branched groups, such as normal, and where applicable iso, sec, and the like, wherein unsaturation (when applicable) can occur in any portion of the group, such as the 1-, 2-, 3- ,4-, or 5-position.

### Platinum Group Metal-Containing Catalyst

The composition that is contacted with the film optionally includes a platinum-group metal-containing catalyst. In some embodiments, the composition that is contacted with the film includes a platinum-containing catalyst. In other embodiments, the composition that is contacted with the film does not include a platinum-containing catalyst. In some embodiments, one platinum-containing hydrosilylation catalyst can be used. In some embodiments, a mixture of catalysts can be used, including two or more different catalysts that differ in at least one property, such as structure, form, platinum group metal, or complexing ligand.

During contacting of the film, the platinum-containing hydrosilylation catalyst can catalyze an addition reaction (hydrosilylation) of the Si—H groups of the silicone elastomer with the unsaturated groups of the poly(alkylene oxide). The platinum-containing hydrosilylation catalyst can be any hydrosilylation catalyst including a platinum group metal or a compound containing a platinum group metal. Platinum group metals include platinum, rhodium, ruthenium, palladium, osmium and iridium. Typically, the platinum group metal is platinum, based on its high activity in hydrosilylation reactions.

Examples of platinum-containing hydrosilylation catalysts include the complexes of chloroplatinic acid and certain vinyl-containing organosiloxanes disclosed by Willing in U.S. Pat. No. 3,419,593, such as the reaction product of chloroplatinic acid and 1,3-divinyl-1,1,3,3-tetramethyldisiloxane; microencapsulated hydrosilylation catalysts including a platinum group metal encapsulated in a thermoplastic resin, as exemplified in U.S. Pat. No. 4,766,176 and U.S. Pat. No. 5,017,654; and photoactivated hydrosilylation catalysts, such as platinum(II) bis(2,4-pentanedioate), as exemplified in U.S. Pat. No. 7,799,842. An example of a suitable hydrosilylation catalyst includes a platinum(IV) complex of 1,3-diethenyl-1,1,3,3-tetramethyldisiloxane.

The concentration of the one or more hydrosilylation catalysts can be sufficient to catalyze hydrosilylation of the unsaturated groups poly(alkylene oxide) and Si—H groups of the silicone elastomer. Typically, the concentration of the hydrosilylation catalyst is sufficient to provide about 0.1 to about 1000 ppm of a platinum group metal, about 0.5 to about 500 ppm of a platinum group metal, or about 1 to about 100 ppm of a platinum group metal, based on the total weight of the uncured poly(ethylene oxide)-containing composition.

### Film

The silicone membrane is a cured product of a composition-contacted film. The composition-contacted film includes a silicone elastomer having a plurality of silicon-bonded hydrogen atoms. The present invention can include the step of forming the film. The film can be formed on at least one surface of a substrate. For any film to be considered “on” a substrate, the film can be attached (e.g. adhered) to the substrate, or be otherwise in contact with the substrate without being adhered. The substrate can have any surface texture, and can be porous or non-porous. The substrate can include surfaces that are not coated with the film by the step of forming the film. All surfaces of the substrate can be coated by the step of forming the film, one surface can be coated, or any number of surfaces can be coated.

The step of forming the film can include two steps. In the first step, the composition that forms the film can be applied to at least one surface of the substrate. In the second step, the applied composition that forms the film can be cured to form the film. In some embodiments, the curing process of the composition can begin before, during, or after application of the composition to the surface. The curing process transforms the composition that forms the film into the film. The composition that forms the film can be in a liquid state. The film can be in a solid state.

The composition that forms the film can be applied using conventional coating techniques, for example, immersion coating, die coating, blade coating, extrusion, curtain coating, drawing down, solvent casting, spin coating, dipping, spraying, brushing, roll coating, extrusion, screen-printing, pad printing, or inkjet printing.

Curing the composition that forms the film can include the addition of a curing agent or initiator such as, for example, a hydrosilylation catalyst. In some embodiments, the curing process can begin immediately upon addition of the curing agent or initiator. The addition of the curing agent or initiator may not begin the curing process immediately, and can require additional curing steps. In other embodiments, the addition of the curing agent or initiator can begin the curing process immediately, and can also require additional curing steps. The addition of the curing agent or initiator can begin the curing process, but not bring it to a point where there composition is cured to the point of being fully cured, or of being unworkable. Thus, the curing agent or initiator can be added before or during the coating process, and further processing steps can complete the cure to form the film. Curing the composition that forms the film can include a variety of methods, including exposing to ambient temperature, elevated temperature, ambient pressure, elevated pressure, reduced pressure or vacuum, ambient environment, controlled environments, convective flows, moisture, or radiation. In some embodiments, curing the composition can include a combination of methods.

The film can have any suitable shape. In some examples, the shape of the film is suitable for formation of, after contacting with the poly(alkylene oxide), a plate-and-frame membrane, a spiral wound membrane, a tubular membrane, a capillary fiber membrane or a hollow fiber membrane. For example, the film can have a shape similar to or identical to the shape of the desired silicone membrane prior to the contacting, such as at least one of formed into hollow fibers and potted in a fiber module prior to contacting with the poly(alkylene oxide). In a hollow fiber film, the exterior of the fiber is one major surface, and the interior of the fiber is the other opposed major surface. The film can be a continuous or discontinuous layer of material.

The film can have any suitable thickness. In some examples, the film has a thickness of about 1 μm, 2, 3, 4, 5, 10, 15, 20, 25, 50, 75, 100, 125, 150, 175, 200, 225, 250, 275, or about 300 μm, such as about 1 μm to 20 μm, about 0.1 μm to 200 μm, about 0.1 μm to 300 μm, or about 0.01 μm to 2000 μm. Before, during, or after the curing process, the thickness or shape of the composition can be altered via any suitable means, for example leveled or otherwise adjusted, such that the film that results after the curing process has the desired thickness and shape. In one example, a doctor blade or drawdown bar is used to adjust the thickness of the applied composition. In another example, a conical die is used to adjust the thickness of the applied composition on a fiber that is later removed.

### Silicone Elastomer

The silicone membrane is a cured product of a composition-contacted film. The composition-contacted film includes a silicone elastomer having a plurality of silicon-bonded hydrogen atoms. The silicone elastomer can be any suitable silicone elastomer having more than one silicon-bonded hydrogen atom per molecule, such as about 2, 3, 4, 5, 10, 15, 20, 50, 100, 200, 300, 400, 500, 600, 700, 800, 900, 1000, 10,000, or about 20,000 Si—H groups per molecule. The silicone elastomer can be a large crosslinked polymer having very high molecular weight, wherein at least one of the crosslinked polymers that comprises the elastomer has about, 1, 2, 3, 4, 5, 10, 15, 20, 50, 100, 200, 300, 400, 500, 600, 700, 800, 900, 1000, 10,000, or about 20,000 Si—H groups, so long as the elastomer has more than one silicon-bonded hydrogen atom. The silicone elastomer can have about 0.001 wt % active H, or about 0.01, 0.1, 0.2, 0.3, 0.4, 0.5, 0.8, 1.0, 1.5, 1.6, 1.7, 2, 1, 2, 3, 4, or about 4.4 wt % active H (e.g the wt % of hydrogen atoms that are bound to silicon atoms).

The silicone elastomer includes the cured product of an organosilicon composition. The organosilicon composition can be any suitable organosilicon composition. The curing of the organosilicon composition gives the silicone elastomer.

The curable silicone composition can include molecular components that have properties that allow the composition to be cured. In some embodiments, the properties that allow the silicone composition to be cured are specific functional groups. In some embodiments, an individual compound contains functional groups or has properties that allow the silicone composition to be cured by one or more curing methods. In some embodiments, one compound can contain functional groups or have properties that allow the silicone composition to be cured in one fashion, while another compound can contain functional groups or have properties that allow the silicone composition to be cured in the same or a different fashion. The functional groups that allow for curing can be located at pendant or, if applicable, terminal positions in the compound.

The silicon composition can include an organic compound. The organic compound can be any suitable organic compound. The organic compound can be, for example, an organosilicon compound. The organosilicon compound can be any organosilicon compound. The organosilicon compound can be, for example, a silane, polysilane, siloxane, or a polysiloxane, such as any suitable one of such compound as known in the art. The silicone composition can contain any number of suitable organosilicon compounds, and any number of suitable organic compounds. An organosilicon compound can include any functional group that allows for curing.

In some embodiments, the organosilicon compound can include a silicon-bonded hydrogen atom, such as organohydrogensilane or an organohydrogensiloxane. In some embodiments, the organosilicon compound can include an alkenyl group, such as an organoalkenylsilane or an organoalkenyl siloxane. In other embodiments, the organosilicon compound can include any functional group that allows for curing. The organosilane can be a monosilane, disilane, trisilane, or polysilane. Similarly, the organosiloxane can be a disiloxane, trisiloxane, or polysiloxane. The structure of the organosilicon compound can be linear, branched, cyclic, or resinous. Cyclosilanes and cyclosiloxanes can have from 3 to 12 silicon atoms, alternatively from 3 to 10 silicon atoms, alternatively from 3 to 4 silicon atoms.

In one example, an organohydrogensilane can have the formula HR¹₂Si—R²—SiR¹₂H, wherein R¹ is C₁₋₁₀ hydrocarbyl or C₁₋₁₀ halogen-substituted hydrocarbyl, both free of aliphatic unsaturation, linear or branched, and R² is a hydrocarbylene group free of aliphatic unsaturation having a formula selected from monoaryl such as 1,4-disubstituted phenyl, 1,3-disubstituted phenyl; or bisaryl such as 4,4′-disubstituted-1,1′-biphenyl, 3,3′-disubstituted-1,1′-biphenyl, or similar bisaryl with a hydrocarbon chain including 1 to 6 methylene groups bridging one aryl group to another.

The organosilicon compound can be an organopolysiloxane compound. In some examples, the organopolysiloxane compound has an average of at least one, two, or more than two functional groups that allow for curing. The organopolysiloxane compound can have a linear, branched, cyclic, or resinous structure. The organopolysiloxane compound can be a homopolymer or a copolymer. The organopolysiloxane compound can be a disiloxane, trisiloxane, or polysiloxane.

In one example, an organopolysiloxane can include a compound of the formula

R¹₃SiO(R¹₂SiO)_{α}(R¹R²SiO)_{β}SiR¹₃, or (a)

R⁴R³₂SiO(R³₂SiO)_{χ}(R³R⁴SiO)_{δ}SiR³₂R⁴. (b)

In formula (a), α has an average value of about 0 to about 2000, and β has an average value of about 2 to about 2000. Each R¹ is independently a monovalent functional group. Suitable monovalent functional groups include, but are not limited to, acrylic groups; alkyl; halogenated hydrocarbon groups; alkenyl; alkynyl; aryl; and cyanoalkyl. Each R² is independently a functional group that allows for curing of the silicone composition, or R¹.

In formula (b), χ has an average value of 0 to 2000, and δ has an average value of 0 to 2000. Each R³ is independently a monovalent functional group. Suitable monovalent functional groups include, but are not limited to, acrylic groups; alkyl; halogenated hydrocarbon groups; alkenyl; alkynyl; aryl; and cyanoalkyl. Each R⁴ is independently a functional group that allows for curing of the silicone composition, or R³.

An organopolysiloxane compound can contain an average of about 0.1 mole % to about 100 mole % of functional groups that allow for curing of the silicone composition, and any range of mole % therebetween. The mole percent of functional groups that allow for curing of the silicone composition in the resin is the ratio of the number of moles of siloxane units in the resin having a functional group that allows for curing of the silicone composition to the total number of moles of siloxane units in the organopolysiloxane, multiplied by 100.

The organopolysiloxane compound can be a single organopolysiloxane or a combination including two or more organopolysiloxanes that differ in at least one of the following properties: structure, viscosity, average molecular weight, siloxane units, and sequence.

Examples of organopolysiloxanes can include compounds having the average unit formula

(R¹R⁴R⁵SiO_{1/2})_{w}(R¹R⁴SiO_{2/2})ₓ(R⁴SiO_{3/2})_{y}(SiO_{4/2})_{z} (I),

wherein R¹ is a functional group independently selected from any optionally further substituted C₁₋₁₅ functional group, including C₁₋₁₅ monovalent aliphatic hydrocarbon groups, C₄₋₁₅ monovalent aromatic hydrocarbon groups, and monovalent epoxy-substituted functional groups, R⁴ is a functional group that allows for curing of the silicone composition or R⁵ or R¹, R⁵ is R¹ or R⁴, 0≦w<0.95, 0≦x<1, 0≦y<1, 0≦z<0.95, and w+x+y+z≈1. In some embodiments, R¹ is C₁₋₁₀ hydrocarbyl or C₁₋₁₀ halogen-substituted hydrocarbyl, both free of aliphatic unsaturation, or C₄ to C₁₄ aryl. In some embodiments, w is from 0.01 to 0.6, x is from 0 to 0.5, y is from 0 to 0.95, z is from 0 to 0.4, and w+x+y+z≈1.

### Curing

The silicone elastomer includes a cured product of a silicone composition. Various methods of curing can be used, including any suitable method of curing, including for example hydrosilylation curing, condensation curing, free-radical curing, amine-epoxy curing, radiation curing, cooling, or any combination thereof. A composition that is cured via one curing method can be cured by other curing methods in addition to the one curing method. The silicone composition can include molecules with properties that allow one curing method, as well as molecules that allow different curing methods. In some embodiments, the silicone composition can include multiple features on the same molecule that allow the composition to be cured via one curing method and cured via other curing methods, and in some embodiments, the silicone composition can include features that allow it to be cured via one curing method on one molecule and features that allow it to be curing via other curing methods on a different molecule.

A silicone composition that is curable via a particular method can include other compounds curable via the particular method in addition to silicone compounds. In some embodiments, the other compounds curable via the particular curing method can participate with the silicone compounds curable via the particular curing method during the application of the particular curing method. In other embodiments, the other compounds curable via the particular curing method do not participate with the silicone compounds curable via the particular curing method during application of the particular curing method.

### Optional Ingredients

The silicone composition that forms the silicone elastomer, and the composition that contacts the film, can optionally include any suitable ingredient; the possible optional ingredients are not limited to those described herein.

The silicone composition that forms the silicone elastomer can include a siliceous filler. Examples of siliceous fillers include various forms of silicas and silicates, including metallosilicates, fumed silica, colloidal silica, precipitated silica, diatomaceous silica, silica gel, quartz, crystalline quartz, fused quartz, mica, zeolites, and clay. In one example, the filler is ground quartz. Suitable siliceous fillers encompass any form of the filler, including fibrous, granular or powder form, including nanoparticles. One or more solvents can be optionally added, for example to lower the viscosity of the composition.

Cure inhibitors can optionally be added. Any suitable platinum group type inhibitor can be used. Nonlimiting suitable platinum catalyst inhibitors include acetylenic inhibitors, olefinic siloxanes and polymethylvinylcyclosiloxanes having three to six methylvinylsiloxane units per molecule. Examples of acetylenic inhibitors can include acetylenic alcohols, such as 2-methyl-3-butyn-2-ol or 1-ethynyl-2-cyclohexanol which can suppress the activity of a platinum-based catalyst at 25° C. The amount of inhibitor present can range from about 0 to about 0.1% (by weight) and in other embodiments can range up to about 0.5% (by weight) based on the amount by total weight of components in the composition.

### Supported Membrane

In some embodiments of the present invention, the membrane is supported on a porous or highly permeable non-porous substrate. A supported membrane has the majority of the surface area of at least one of the two major sides of the membrane contacting a porous or highly permeable non-porous substrate. A supported membrane on a porous substrate can be referred to as a composite membrane, where the membrane is a composite of the membrane and the porous substrate. The porous substrate on which the supported membrane is located can allow gases to pass through the pores and to reach the membrane. The supported membrane can be attached (e.g. adhered) to the porous substrate. The supported membrane can be in contact with the substrate without being adhered. The porous substrate can be partially integrated, fully integrated, or not integrated into the membrane.

To form the film that can be contacted with the composition to form a supported silicone membrane, a coating can be formed on the at least one porous surface of the substrate or on the at least one surface of the highly permeable non-porous substrate. Alternately, a porous or highly permeable non-porous substrate can be placed in contact with the formed coating before, during, or after curing of the coating. Then, the cured coating (e.g., the film) can be contacted with the composition including the poly(alkylene oxide). In some examples, a porous substrate can have its pores filled at the surface to provide a smooth surface for formation of the film; after formation of the film or membrane, the composition filling the pores can be dried or otherwise removed or shrunk to restore the porosity of the substrate. In some examples, the supported membrane is made in a manner identical to that disclosed herein pertaining to a free-standing membrane, but with the additional step of placing or adhering the free-standing film or membrane on a porous substrate to make a supported membrane. The contacting of the film with the composition including the poly(alkylene oxide) can occur before or after placing or adhering a free-standing film on a porous substrate to make a supported membrane.

The porous substrate can be any suitable porous material known to one of skill in the art, in any shape. For example, the substrate can be a filter. The porous substrate can be woven or non-woven. The porous substrate can be a frit, a porous sheet, or a porous hollow fiber. The porous substrate can be glass, ceramic, alumina, or a porous polymer. For example, the at least one surface can be flat, curved, or any combination thereof. The surface can have any perimeter shape. The porous substrate can have any number of surfaces, and can be any three-dimensional shape. Examples of three-dimensional shapes include cubes, spheres, cones, and planar sections thereof with any thickness, including variable thicknesses. The porous substrate or highly permeable non-porous substrate can be smooth, be corrugated or patterned, or have any amount of surface roughness. The porous substrate can have any number of pores, and the pores can be of any size, depth, shape, and distribution. In one example, the porous substrate has a pore size of about 0.2 nm to about 500 μm. The at least one surface can have any number of pores. In some examples, the pore size distribution may be asymmetric across the thickness of the porous sheet, film or fiber. In some examples, the porous substrate has a thickness of about 0.2 nm to about 500 μm, or about 1-100 μm, or about 5-60 μm, or about 10-40 μm.

Suitable examples of porous substrates include porous polymeric films, fibers or hollow fibers, or porous polymers or any suitable shape or form. Examples of polymers that can form porous polymers suitable for use as a porous substrate in embodiments of the present invention include those disclosed in U.S. Pat. No. 7,858,197. For example, suitable polymers include polyethylene, polypropylene, polysulfones, polyethersulfones, polyamides, polyether ether ketone (PEEK), polyarylates, polyaramides, polyethers, polyarylethers, polyimides, polyetherimides, polyphthalamides, polyesters, polyacrylates, polymethacrylates, cellulosics, cellulose acetate, polycarbonates, polyacrylonitrile, polytetrafluoroethylene and other fluorinated polymers, polyvinylalcohol, polyvinylacetate, syndiotactic or amorphous polystyrene, Kevlar™ and other liquid crystalline polymers, epoxy resins, phenolic resins, polydimethylsiloxane elastomers, silicone resins, fluorosilicone elastomers, fluorosilicone resins, polyurethanes, and copolymers, blends or derivatives thereof. Suitable porous substrates can include, for example, porous glass, various forms and crystal forms of porous metals, ceramics and alloys, including porous alumina, zirconia, titania, and steel.

### Unsupported Membrane

In some embodiments of the present invention, the membrane is unsupported, also referred to as free-standing. The majority of the surface area on each of the two major sides of a membrane that is free-standing is not contacting a substrate, whether the substrate is porous or not. In some embodiments, a membrane that is free-standing can be 100% unsupported. A membrane that is free-standing can be supported at the edges or at the minority (e.g. less than 50%) of the surface area on either or both major sides of the membrane. The support for a free-standing membrane can be a porous substrate or a nonporous substrate. Examples of suitable supports for a free-standing membrane can include any examples of supports given in the above section Supported Membrane. A free-standing membrane can have any suitable shape, regardless of the percent of the free-standing membrane that is supported. Examples of suitable shapes for free-standing membranes include, for example, squares, rectangles, circles, tubes, cubes, spheres, cones, and planar sections thereof, with any thickness, including variable thicknesses. For example, a free-standing membrane can include a plate membrane, a spiral membrane, tubular membrane, and hollow fiber membrane.

In some embodiments, a free-standing membrane is made by the steps of coating or applying a composition onto a substrate, curing the composition, and partially or fully removing the film or membrane from the substrate. The composition including the poly(alkylene oxide) can be contacted to the film before or after removal from the substrate. After application of the composition to the substrate, the assembly can be referred to as a laminated film or fiber. During or after the curing process the film can be at least partially removed from at least one substrate. In some examples, after the unsupported film or membrane is removed from a substrate, the unsupported film or membrane is attached to a support, as described above. In some examples, an unsupported membrane is made by the steps of coating a composition onto one or more substrates, curing the composition, and removing the film or membrane from at least one of the one or more substrates, while leaving at least one of the one of more substrates in contact with the film or membrane, and contacting the composition including the poly(alkylene oxide) to the film before or after removal from the substrate. In some embodiments, the membrane or film is entirely removed from the substrate. In one example, the membrane or film can be peeled away from the substrate. In one example, the substrate can be removed from the film or membrane by melting, subliming, chemical etching, or dissolving in a solvent. In one example, the substrate is a water soluble polymer that is dissolved by purging with water. In one example, the substrate is a fiber or hollow fiber, as described in U.S. Pat. No. 6,797,212 B2.

A support for a free-standing membrane can be attached to the film or membrane in any suitable manner, for example, by clamping, with use of adhesive, by melting the film or membrane to the edges of the substrate, or by chemically bonding the film or membrane to the substrate by any suitable means. The support for the free-standing membrane can be not attached to the membrane but in contact with the membrane and held in place by friction or gravity. The support can include, for example, a frame around the edges of the membrane, which can optionally include one or more cross-beam supports within the frame. The frame can be any suitable shape, including a square or circle, and the cross-beam supports, if any, can form any suitable shape within the frame. The frame can be any suitable thickness. The support can be, for example, a cross-hatch pattern of supports for the membrane, where the cross-hatch pattern has any suitable dimensions.

In examples that include a substrate, the substrate can be porous or nonporous. The substrate can be any suitable material, and can be any suitable shape, including planar, curved, solid, hollow, or any combination thereof. Suitable materials for porous or nonporous substrates include any materials described above as suitable for use as porous substrates in supported membranes, as well as any suitable less-porous materials. In some examples, the membrane can be heated, cooled, washed, etched or otherwise treated to facilitate removal from the substrate. In other examples, air pressure can be used to facilitate removal of the membrane from the substrate.

### Method of Separating Gas Components in a Feed Gas Mixture

The present invention also provides a method of separating gas components or water vapor in a feed gas mixture by use of the membrane described herein. The method includes contacting a first side of a membrane with a feed gas mixture to produce a permeate gas mixture on a second side of the membrane and a retentate gas mixture on the first side of the membrane. The permeate gas mixture is enriched in the first gas component. The retentate gas mixture is depleted in the first gas component. The membrane can include any suitable membrane as described herein. The treated side of the membrane can face the feed side or the permeate side.

The membrane can be free-standing or supported by a porous or permeable substrate. In some embodiments, the pressure on either side of the membrane can be about the same. In other embodiments, there can be a pressure differential between one side of the membrane and the other side of the membrane. For example, the pressure on the retentate side of the membrane can be higher than the pressure on the permeate side of the membrane. In other examples, the pressure on the permeate side of the membrane can be higher than the pressure on the retentate side of the membrane. In some examples, one of the sides of the membrane can be swept by a separate sweep fluid that is a gas or liquid. For example, the permeate side of the membrane can be swept by a sweep fluid that is depleted in the first gas component and depleted in any other gases that are being removed from the feed mixture to enhance the efficiency of separation.

The feed gas mixture can include any mixture of gases. For example, the feed gas mixture can include hydrogen, carbon dioxide, nitrogen, ammonia, methane, water vapor, hydrogen sulfide, or any combination thereof. The feed gas can include any gas known to one of skill in the art. The membrane can be selectively permeable to any one gas in the feed gas, or to any of several gases in the feed gas. The membrane can be selectively permeable to all but any one gas in the feed gas.

Any number of membranes can be used to accomplish the separation. For example, one membrane can be used. The membranes can be manufactured as flat sheets or as fibers and can be packaged into any suitable variety of modules including hollow fibers, sheets or arrays of hollow fibers or sheets. Common module forms include hollow fiber modules, spiral wound modules, plate-and-frame modules, tubular modules and capillary fiber modules.

In embodiments, the membrane can be used to separate liquids. In some embodiments, the membrane can be used to separate a gas from a liquid. In some embodiments the membrane can be used to deliver a gas or vapor into a liquid. In another embodiment, the membrane can be used to separate a liquid from a gas. In another example, the membrane can be used to separate a gas from a gas that contains a suspended solid or liquid. In another example, the membrane can be used to separate a liquid from a liquid that contains a suspended or dissolved solid or gas.

In some embodiments, the feed gas mixture includes carbon dioxide and at least one of nitrogen and methane and the permeate gas mixture is enriched in carbon dioxide. In some embodiments, the feed gas mixture includes water vapor and the permeate gas mixture is enriched in water vapor.

The present invention can be better understood by reference to the following examples which are offered by way of illustration. The present invention is not limited to the examples given herein.

### REFERENCE EXAMPLE 1

### Membrane Preparation

Prior to preparing membranes, the compositions described in the Examples and Comparative Examples were placed in a vacuum chamber under a pressure of less than 50 mm Hg for 5 minutes at ambient laboratory temperature (21± about 2° C.) to remove any entrained air. Films were then prepared by drawing the composition described in the Examples into a uniform thin film with a doctor blade onto a polytetrafluoroethylene (PTFE, Teflon® brand) release film. The samples were then immediately placed into a forced air convection oven at a time and temperature sufficient to cure the films. After curing, and after any surface treatment procedures, membranes still attached to release films were then recovered by carefully peeling the cured compositions from the release film, and membranes were transferred onto a fritted glass support for testing of permeation properties as described in Reference Example 2. The thickness of the samples was measured with a profilometer (Tencor P11 Surface Profiler).

### REFERENCE EXAMPLE 2

### Permeation Measurements

Gas permeability coefficients and ideal selectivities in a binary gas mixture were measured by a permeation cell including an upstream (feed) and downstream (permeate) chambers that are separated by the membrane. Each chamber had one gas inlet and one gas outlet. The upstream chamber was maintained at 35 psi pressure and was constantly supplied with an equimolar mixture of CO₂ and N₂ at a flow rate of 200 standard cubic centimeters per minute (sccm). The membrane prepared according the method of Reference Example 1 was supported on a glass fiber filter disk with a diameter of 83 mm and a maximum pore diameter range of 10-20 μm (Ace Glass). In all experiments where one or more surfaces of the membrane was treated, the membrane was oriented in the permeation cell such that the more highly treated side was facing the feed stream. The membrane area was defined by a placing a butyl rubber gasket with a diameter of 50 mm (Exotic Automatic & Supply) on top of the membrane. The downstream chamber was maintained at 5 psi pressure and was constantly supplied with a pure He stream at a flow rate of 20 sccm. To analyze the permeability and separation factor of the membrane, the outlet of the downstream chamber was connected to a 6-port injector equipped with a 1-mL injection loop. On command, the 6-port injector injected a 1-mL sample into a gas chromatograph (GC) equipped with a thermal conductivity detector (TCD). The amount of gas permeated through the membrane was calculated by calibrating the response of the TCD detector to the gases of interest. The reported values of gas permeability and selectivity were obtained from measurements taken after the system had reached a steady state in which the permeate side gas composition became invariant with time. All experiments were run at ambient laboratory temperature (21± about 2° C.).

### REFERENCE EXAMPLE 3

### Attenuated Total Reflectance Infrared (ATR-IR) Spectroscopy

Samples were tested at ambient laboratory conditions using a Nicolet 6700 FTIR equipped with a Smart Miracle accessory having a zinc selenide crystal. Samples soaked in water were first blotted completely dry with a Kimwipe before being placed face-down (where face is the surface exposed to air during curing, and the back is the surface cured in contact with the release liner) on the crystal and brought into light contact with a clamp. Data acquisition was conducted within 5 minutes of removal from solution to minimize hydrophobic recovery upon exposure to air. The contact pressure was kept to the minimum needed to establish complete crystal contact, as judged by previewing the spectral quality. Comparison of SiH and SiOH peak heights (around 2160 cm⁻¹ and broad signal around 3390 cm⁻¹ respectively) among samples was done with identical baseline points and normalized by a suitable internal reference peak for the asymmetric CH₃ deformation at 1446 cm⁻¹. Relative concentrations over water exposure time were reported by then taking the ratio to the original data point at time zero (e.g., for Examples 1-4, prior to exposure to a solution).

### REFERENCE EXAMPLE 4

### Water Vapor Permeation Measurements

Water vapor permeability coefficients in a binary gas mixture were measured by a permeation cell including an upstream (feed) and a downstream (permeate) chamber that are separated by the membrane. The upstream and downstream chambers were maintained at 35 psig and 5 psig pressures, respectively. The membrane was supported on a glass fiber filter disk with a diameter of 83mm and a maximum pore diameter range of 10-20 □m (Ace Glass). The membrane area was defined by a placing a butyl rubber gasket with a diameter of 35 mm (Exotic Automatic & Supply) on top of the membrane. An air supply of 1200 sccm was provided, with 800 sccm of the air passing through a bubbler (Swagelok 500 mL steel cylinder containing water) to become enriched with water and 400 sccm of the air bypassing the bubbler and remaining dry. Air flow rates were controlled by rotameters. The wet and dry air streams then combined, and the relative humidity (RH) of the resultant feed stream was measured with a moisture transmitter (GE DewPro MMR31) and was determined to maintain a RH of about 62% under the experimental conditions. This stream was fed continuously into the upstream chamber of the permeation cell, and a helium sweep of 100 sccm was supplied continuously to the downstream chamber of the cell. The portion of the feed that permeated the membrane then combined with the helium sweep, and the resultant stream exited the downstream chamber. The RH of this stream was measured with a moisture transmitter (Omega HX86A) and the flow rate was measured with a soap bubble flow meter, in which the amount of time required for a bubble to rise to a height corresponding to 5 mL was used to determine flow rate. The portion of the feed that did not permeate the membrane exited the upstream chamber as the retentate stream. The system was allowed to attain equilibrium, which was defined as the time at which the RH of both the feed stream and the stream exiting the downstream chamber remained constant. The effective water vapor permeability coefficient for each membrane sample was calculated using the equation

$$\frac{\dot{Q}}{A} = \frac{P}{l} ( {[ RH * {p}_{sat} ]}_{feed} - {[ RH * {p}_{sat} ]}_{permeate} )$$

in which \dot{Q} is the volumetric flow rate of water vapor through the membrane, A is the area of the membrane, P is the permeability coefficient for water vapor, l is film thickness, and pₛₐₜ is saturation pressure. To analyze nitrogen permeability, the outlet of the downstream chamber was connected to a 6-port injector equipped with a 1-mL injection loop. On command, the 6-port injector injected a 1-mL sample into a gas chromatograph (GC) equipped with a thermal conductivity detector (TCD). The amount of nitrogen permeated through the membrane was calculated by calibrating the response of the TCD detector to the gases of interest. All experiments were run at ambient laboratory temperature (21± about 2° C.).

### COMPARATIVE EXAMPLE 1

Part A of a 2-part siloxane composition was prepared by combining a mixture including 97.1 parts of siloxane-silsesquioxane blend (Blend 1) consisting essentially of 73 parts of dimethylvinylsiloxy-terminated polydimethylsiloxane having a viscosity of about 55 Pa·s at 25° C. and 27 parts of organopolysiloxane resin consisting essentially of CH₂═CH(CH₃)₂SiO_{1/2} units, (CH₃)₃SiO_{1/2} units, and SiO_{4/2} units, wherein the mole ratio of CH₂═CH(CH₃)₂SiO_{1/2} units and (CH₃)₃SiO_{1/2} units combined to SiO_{4/2} units is about 0.7, and the resin has weight-average molecular weight of about 22,000, a polydispersity of about 5, and contains about 1.8% by weight (about 5.5 mole %) of vinyl groups, and 2.43 parts of an oligomeric dimethylsiloxane(D)-methylvinylsiloxane(D^{Vi}) diol (MV Diol) having a D:D^{Vi} ratio of about 1 and a viscosity of about 0.02 Pa·s at 25° C., and 0.48 parts of a catalyst (Catalyst 1) including a mixture of 1% of a platinum(IV) complex of 1,1-diethenyl-1,1,3,3-tetramethyldisiloxane, 92% of dimethylvinylsiloxy-terminated polydimethylsiloxane having a viscosity of about 0.45 Pa·s at 25° C., and 7% of tetramethyldivinyldisiloxane.

The Part A was mixed in a Hauschild rotary mixer for two 30 s mixing cycles, with a manual spatula-mixing step between the first two cycles. Part B of the 2-part siloxane composition was prepared in a similar manner by combining 46.39 parts of Blend 1, 51.02 parts of trimethylsiloxy-terminated polyhydridomethylsiloxane polymer (PHMS 1) having a viscosity of about 0.24 Pa·s at 25° C., and 2.29 parts of a polydimethylsiloxane-polyhydridomethylsiloxane copolymer having an average viscosity of about 0.03 Pa·s at 25° C. and including 1 wt % H in the form of SiH (PDMS-PHMS) and 0.30 parts of 2-methyl-3-butyn-2-ol. 3.3 parts of Part A and 6.7 parts of Part B were then combined, along with 2.50 g of ground quartz (Min-U-Sil 5, US Silica) in a polypropylene cup and mixed with a Hauschild rotary mixer for two 40 s cycles with a manual spatula mixing step in between cycles. The composition was de-aired for about 5 minutes in a vacuum chamber at a pressure of <50 mm Hg, then drawn into films with a 4 mil doctor blade onto a PTFE release liner backing sheet and cured for 30 min at 100° C.

### EXAMPLES 1-4

In a polypropylene mixing cup was combined 10.0 g of a mono-allyl-terminated polyethylene glycol having a number average degree of polymerization of approximately 12 (Dow Chemical Company, SF-501) and 0.03 g of Catalyst 1 and mixed for 30 s in a Hauschild rotary mixer, then poured into a glass crystallizing dish to form a solution. Each membrane (e.g., film) was first prepared as described in Comparative Example 1. The membranes (e.g., films) with the PTFE release liner intact were then each placed into contact with a separate container of the solution with the silicone side face-down. The membranes were then allowed to react with the solution on the silicone surface by heating the sample dishes on a hot plate set at 90° C. and allowing the reaction to proceed for 1 hour at a membrane surface temperature of 70-75° C. measured by an infrared thermometer. Excess solution was then removed from the treated silicone side of the membrane (the face of the membrane) by gentle wiping with a clean laboratory wipe (Kimberly Clark Kimwipe®) and rinsed thoroughly and repeatedly with fresh deionized water. The membrane samples were given a final wiping with a clean laboratory wipe and allowed to dry, then analyzed by the method of Reference Example 2 on both the face and back (cured against the PTFE backing) surfaces.

All the samples were then tested for mixed gas membrane permeability and selectivity using the method of Reference Example 2. In Examples 1 and 2 the backing was allowed to float off the back of the membrane to expose both sides of the silicone film to the solution during heating. In Examples 3 and 4 the backing remained on the membrane during the heating. As can be seen in Table 1, differences among sample treatment are reflected in the ATR-IR peak height ratios between the polyethylene glycol C-H stretch (2870 cm⁻¹) and the C—H stretch from the Si—CH₃ groups (2962 cm⁻¹), which serves as an internal reference. The extent of surface reaction is also evident in the disappearance of the SiH peak (2166 cm⁻¹) and reduction in the SiH:Si—CH₃ peak height ratios, relative to those obtained from the original surfaces of Comparative Example 1.

TABLE 1

| | ATR-IR Peak Heights | | | | | | | CO₂ | | |
|---|---|---|---|---|---|---|---|---|---|---|
| | Peak | 2870 | 2962 | 2166 | Peak Height Ratios | | Thickness | Permeability | Selectivity | Permeance |
| Example | (cm⁻¹) | PEG | Si—CH₃ | SiH | SI—H:Si—Me | PEG:Si—Me | μm | Barrer | CO₂/N₂ | (GPU) |
| Comparative | face | 0.0011 | 0.050 | 0.0630 | 1.26 | 0.02 | 113 | 2103 | 11.9 | 18.6 |
| Example 1 | back | 0.0014 | 0.062 | 0.0357 | 0.58 | 0.02 | | | | |
| | | | | Combined: | 1.84 | 0.04 | | | | |
| Example 1 | face | 0.0581 | 0.039 | 0.0057 | 0.15 | 1.49 | 125 | 1113 | 17.8 | 8.9 |
| | back | 0.0501 | 0.049 | 0.0039 | 0.08 | 1.02 | | | | |
| | | | | Combined: | 0.23 | 2.51 | | | | |
| Example 2 | face | 0.0507 | 0.046 | 0.0122 | 0.27 | 1.10 | 125 | 1178 | 16.5 | 9.4 |
| | back | 0.0496 | 0.050 | 0.0075 | 0.15 | 0.99 | | | | |
| | | | | Combined: | 0.42 | 2.09 | | | | |
| Example 3 | face | 0.0520 | 0.043 | 0.0200 | 0.47 | 1.21 | 110 | 1506 | 14.7 | 13.7 |
| | back | 0.0027 | 0.062 | 0.0331 | 0.53 | 0.04 | | | | |
| | | | | Combined: | 1.00 | 1.25 | | | | |
| Example 4 | face | 0.0471 | 0.046 | 0.0191 | 0.42 | 1.02 | 110 | 1523 | 14.5 | 13.8 |
| | back | 0.0025 | 0.063 | 0.0332 | 0.53 | 0.04 | | | | |
| | | | | Combined: | 0.94 | 1.06 | | | | |

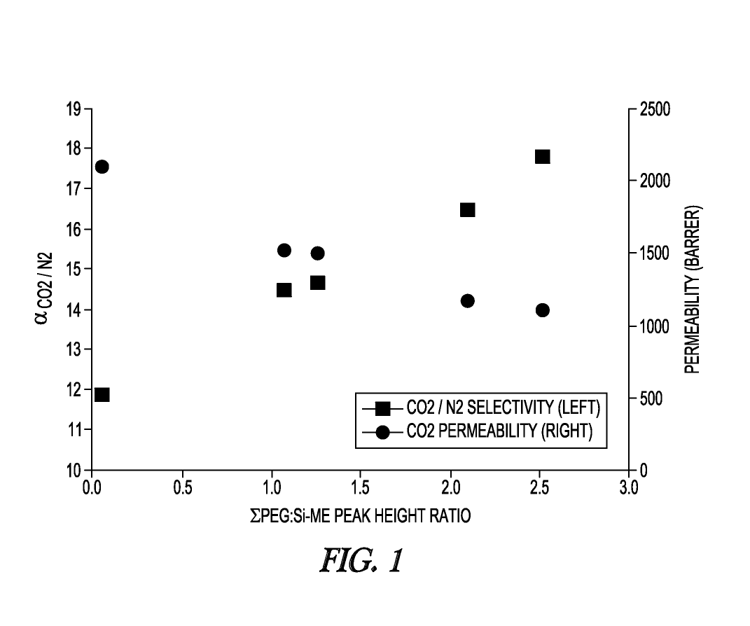

The relationship between level of polyether surface grafting, quantified by the sum of the 2870 cm⁻¹:2962 cm⁻¹ peak height ratios obtained from both the face and back surfaces of each membrane, and the CO₂/N₂ selectivity and CO₂ permeability coefficient is shown in FIG. 1. The strong correlation between polyether surface grafting level and CO₂/N₂ selectivity, and the inverse correlation with CO₂ permeability coefficient, provides evidence that embodiments of the present invention can control and improve the gas separation performance of silicone membranes while maintaining good permeability to at least one of the gases in a mixture.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those of ordinary skill in the art, and that such modifications and variations are considered to be within the scope of this invention as defined by the appended claims.

### EXAMPLE 5

A film was prepared according to the method described for Examples 3 and 4, and tested for water vapor permeability according to the method of Reference Example 4, with film oriented in the permeation cell such that the treated side was facing the feed stream. The resulting permeance was measured to be 302 GPU, corresponding to an effective permeability coefficient of 33,825 Barrer.

We claim:

1. A method of preparing a silicone membrane, the method comprising:
contacting at least one surface of a film comprising a silicone elastomer having a plurality of silicon-bonded hydrogen atoms with a composition comprising an unsaturated poly(alkylene oxide) having the formula R¹O(R²O)ₙR³ and, optionally, a platinum group metal-containing catalyst, for an amount of time sufficient to convert at least a portion of the silicon-bonded hydrogen atoms to silicon-bonded carbon groups, giving a silicone membrane, wherein R¹ is an organic group having at least one unsaturated aliphatic carbon-carbon bond, R² is C₂-C₄ hydrocarbylene, R³ is R¹, H, alkyl, aryl, acyl, alkylacyl, alkoxyacyl, or an epoxy-functional group, n is about 2 to 30, and wherein the silicone membrane has a CO₂ permeance of at least about 8-30 GPU.

2. The method of claim 1, wherein the silicone membrane has a thickness of about 0.1 to 300 μm.

3. The method of claim 1, wherein the poly(alkylene oxide) is at least one of a poly(oxyethylene) having the general formula R¹O(CH₂CH₂O)_{b}R³, a poly(oxypropylene) having the general formula R¹O[CH₂CH(CH₃)O]_{b}R³, a poly(oxybutylene) having the general formula R¹O[CH₂CH(CH₂CH₃)O]_{b}R³, and a poly(oxyethylene-oxypropylene) copolymer having the formula R¹O(CH₂CH₂O)_{c}[CH₂CH(CH₃)O]_{d}R³, wherein R¹ and R³ are as defined in claim 1, b has a value such that the number average molecular weight of the poly(alkylene oxide) is about 90 to 4000, and c+d=b.

4. The method of claim 1, wherein one surface of the film is contacted with the composition comprising an unsaturated poly(alkylene oxide).

5. The method of claim 1, wherein two opposing surfaces of the film are contacted with the composition comprising an unsaturated poly(alkylene oxide).

6. The method of claim 1, wherein the surface of the film is contacted with the composition comprising the unsaturated poly(alkylene oxide) at a temperature of about 50 to 150° C.

7. The method of claim 1, further comprising, after contacting the surface, washing the silicone membrane to remove any of the unsaturated poly(alkylene oxide) remaining on the surface.

8. The method of claim 1, wherein the silicone membrane is an unsupported silicone membrane.

9. An unsupported silicone membrane prepared by the method of claim 8, selected from a plate membrane, a spiral membrane, tubular membrane, hollow fiber membrane, and a combination thereof.

10. A supported silicone membrane, comprising:
a substrate; and
a silicone membrane on the substrate, wherein the membrane is prepared by the method of claim 1.

11. The supported silicone membrane of claim 10, wherein the substrate is a porous substrate comprising a frit comprising a material selected from glass, ceramic, alumina, and a porous polymer.

12. A method of separating gas components in a feed gas mixture, the method comprising contacting a first side of the silicone membrane of claim 9 with a feed gas mixture comprising at least a first gas component and a second gas component to produce a permeate gas mixture on a second side of the membrane and a retentate gas mixture on the first side of the membrane, wherein the permeate gas mixture is enriched in the first gas component, and the retentate gas mixture is depleted in the first gas component.

13. The method of claim 12, wherein the feed gas mixture comprises carbon dioxide and at least one of nitrogen and methane and the permeate gas mixture is enriched in carbon dioxide.

14. The method of claim 12, wherein the feed gas mixture comprises water vapor and the permeate gas mixture is enriched in water vapor.

15. A silicone membrane, comprising:
a cured product of a composition-contacted film, the composition-contacted film comprising
a film comprising a silicone elastomer having a plurality of silicon-bonded hydrogen atoms; and
a composition in contact with at least one side of the film, comprising
an unsaturated poly(alkylene oxide) having the formula R¹O(R²O)ₙR³; and
optionally, a platinum group metal-containing catalyst;
wherein R¹ is an organic group having at least one unsaturated aliphatic carbon-carbon bond, R² is C₂-C₄ hydrocarbylene, R³ is R¹, H, alkyl, aryl, acyl, alkylacyl, alkoxyacyl, or an epoxy-functional group, n is about 2 to 30, and
wherein the silicone membrane has a CO₂ permeance of at least about 8-30 GPU.

16. A method of separating gas components in a feed gas mixture, the method comprising contacting a first side of the silicone membrane of claim 10 with a feed gas mixture comprising at least a first gas component and a second gas component to produce a permeate gas mixture on a second side of the membrane and a retentate gas mixture on the first side of the membrane, wherein the permeate gas mixture is enriched in the first gas component, and the retentate gas mixture is depleted in the first gas component.

17. The method of claim 16, wherein the feed gas mixture comprises carbon dioxide and at least one of nitrogen and methane and the permeate gas mixture is enriched in carbon dioxide.

18. The method of claim 16, wherein the feed gas mixture comprises water vapor and the permeate gas mixture is enriched in water vapor.
